(19) United States
(12) Patent Application Publication
(10) Pub. No.: US 2008/0311333 A1
(43) Pub. Date: Dec. 18, 2008

(54) Silicone Release Compositions with Controlled Peeling Force and Silicone Release Coating Films Coated with the Same

(75) Inventors: Jong-Uk Yoon, Gyeongsangbuk-do (KR); Jeong-Woo Lee, Gyeongsangbuk-do (KR); Moon-Bok Lee, Gyeongsangbuk-do (KR); Sang-Pil Kim, Gyeongsangbuk-do (KR)

Correspondence Address: HARNESS, DICKEY, & PIERCE, P.L.C, 7700 Bonhomme, Suite 400, ST. LOUIS, MO, 63105, US

(73) Assignee: TORAY SAEHAN INC., Gumi-si, Gyeongsangbuk-do (KR)

(21) Appl. No.: 12/096,277

(22) PCT Filed: Nov. 20, 2006
(86) PCT No.: PCT/KR2006/004876

§ 371 Date: Jun. 5, 2008

(30) Foreign Application Priority Data
Dec. 7, 2005 (KR) 10-2005-0118821

(51) Int. Cl. B32B 33/00; C08L 83/06

(52) U.S. Cl. 428/41.8; 524/837

(57) ABSTRACT

The invention pertains to a silicone release composition of which the peeling force can be controlled and also a silicone release film coated with the composition. With the inventive composition and the release film coated with the composition, it is possible to obtain a reproducible peeling force with a given value, and also possible to produce a uniformly coated release film without discharged harmful solvent. The silicone release film produced as such can have controlled peeling force with a stable peeling force characteristic compatible with viscous agent. To this end, the invention is characterized in that the silicone release composition of which the peeling force can be controlled according to the invention is a silicone water-dispersed release coating composition, contains organopolysiloxane, organopolysiloxane resin, organo hydrogen polysiloxane and platinum chelate catalyst, and meets the following math figure for peeling force:
Peeling Force=a X+b, where a=61.62±3.98, and b=16.43±3.01, X=the content(%) of organopolysiloxane resin in the release coating composition.

### TECHNICAL FIELD

The present invention relates to a silicone release composition and a silicone release film coated with the composition, and more particularly to a silicone release composition and a silicone release film coated with the composition of which the peeling force can be controlled with a given value for reproducible peeling force, and with which it is possible to produce a release film uniformly coated without discharged harmful organic solvent, the silicone release film produced as such having stable peeling force compatible with viscous agent.

### BACKGROUND ART

Generally, a release film is used as a film for protecting bonding surfaces with viscous agent, adhesive, pasting medicine, etc. or as a carrier sheet for forming a resin sheet, more particularly, a ceramic sheet, an electrode sheet and the like. Recently, as the use and type of optical products are diversified and such optical products are increasingly produced more and more, sticking agent, adhesive and the like tends to change from the liquid phase to a sheet type for the sake of improved productivity. The structure of resin, viscous agent and adhesive in such a sheet type is shown in FIG. 1. When using such a sheet, a release layer on the surface A (light peeling) having a lower peeling force is first removed and the sheet is then joined with an intended part. Subsequently a release layer on the surface B (heavy peeling) having a higher peeling force is removed. In this case, for required physical properties, since the release layers positioned on both sides of the sheet must not be removed at the same time, each release layer must have a difference in the peeling force at a given level. A hardening film made of an additive silicone composition comprising organopolysiloxane, organo hydrogen polysiloxane and platinum catalyst which are basic release coating components is useful for products requiring light peeling capability of lower peeling force, such as labels, tapes, etc. The aforementioned hardening film, however, doesn't have enough capability and is thus not used for the applications requiring heavier peeling force as mentioned above.

To solve the aforementioned problems, a method has been used in which double coating with a release composition is applied to achieve a difference in release force on both sides. In this case, there is a problem of insufficient peeling stability in high-speed peeling. Also, the published Japan Patent applications 07-126532 and 07-252360 disclose the method of using an additive reaction type silicone composition to which organopolysiloxane resin is added, with or without solvent. However, in case of using it with solvent, there may be a problem with respect to environmental pollution or stability. In case of using it without solvent, there may be a problem of increased viscosity of the composition causing lowered coating capability by increasing the amount of added organopolysiloxane resin in order to increase the peeling force of a resultant film.

### DISCLOSURE OF INVENTION

### Technical Problem

The invention was devised to meet the aforementioned need and to solve the typical problems.

It is an object of the present invention to provide a silicone release composition having a specified peeling force reproducible and for forming a stable release coating layer in which the peeling force of a resultant film can be controlled, and a release film coated with the composition.

### Advantageous Effects

It is possible to obtain a desired value for a reproducible given peeling force through an inline or offline production process for the silicone release composition of which the peeling force can be controlled according to the invention. According to the invention, it is also possible to produce a uniformly coated release film without discharged harmful organic solvent, and the silicone release film produced as such has a stable peeling force property compatible with viscous agent.

The release film coated with the silicone release composition of which the peeling force can be controlled can have application in protecting for resin, viscous agent and adhesive in a sheet form, and can be effectively and very properly used for a double-sided adhesive tape, etc.

### BRIEF DESCRIPTION OF THE DRAWINGS

These and other features, aspects, and advantages of the present invention will become apparent through the following description, illustrated in the appended drawings. In the drawings:

FIG. 1 shows a configuration of a release film attached on both sides of a general adhesive sheet;

FIG. 2 is a graph showing peeling forces depending on a composition ratio of organopolysiloxane resin/organopolysiloxane and organo hydrogen polysiloxane/organopolysiloxane; and

FIG. 3 is a graph showing peeling forces depending on the content (%) of organopolysiloxane resin.

### BEST MODE FOR CARRYING OUT THE INVENTION

Hereinafter, preferred embodiments of the present invention will be described in detail with reference to the accompanying drawings.

The silicone release composition according to the invention in which the peeling force can be controlled in order to achieve the aforementioned object is a silicone water-dispersed release coating composition, characterized in that it contains organopolysiloxane, organopolysiloxane resin, organo hydrogen polysiloxane and platinum chelate catalyst, and satisfies the following math figure with respect to its peeling force:

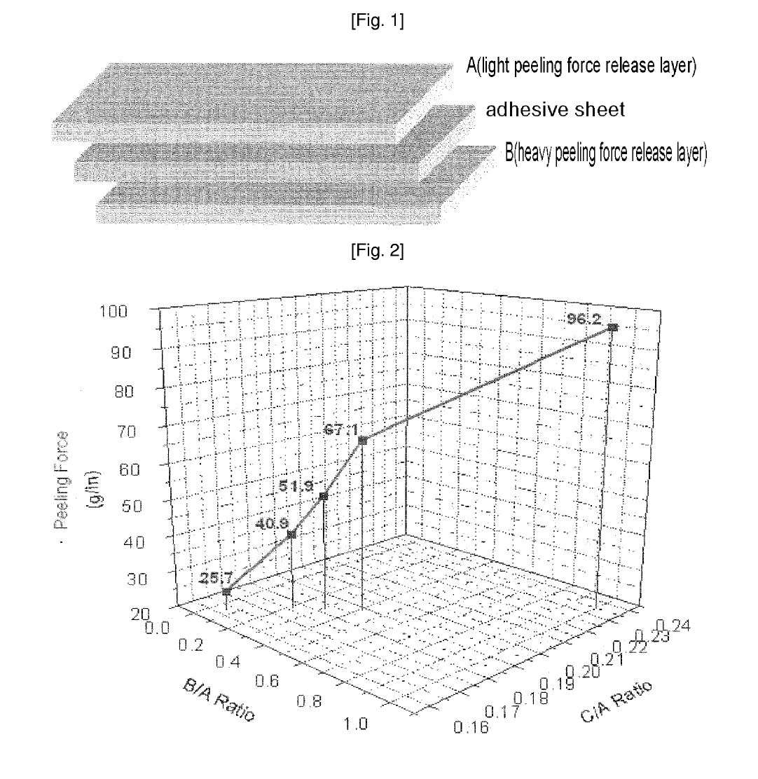

Peeling Force=a X+b Math Figure 1

where =61.62±3.98, b=16.43±3.01, and X=content (%) of organopolysiloxane resin in the release coating composition.

Preferably, the invention is characterized in that the composition contains 6 to 20 weight % of solid matters.

More preferably, the invention is characterized in that the organopolysiloxane resin in the composition in water-dispersed emulsion has a repetitive unit of the structure shown in the following chemistry FIGS. 3 to 5.

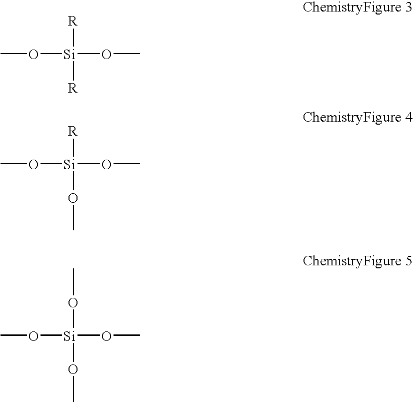

More preferably, the invention is characterized in that R in the chemistry FIGS. 3 to 4 is the methyl group, vinyl group or phenyl group, and the organopolysiloxane resin has a linear or annular structure.

The silicone release film coated with the silicone release composition of which the peeling force can be controlled according to the invention is characterized in that, for the film, a silicone release coating layer is formed by coating one side or both sides of a polyester plastic film to have a given coating thickness with the silicone release composition of which the peeling force can be controlled.

Hereinafter, the invention will be described in detail with reference to the embodiments of the invention. It should be apparent to those skilled in the art that these embodiments are intended only to illustrate the invention in more detail, and the scope of the invention is not to be limited by those embodiments.

The organopolysiloxane which is one component of the silicone release composition of which the peeling force can be controlled according to the invention has a representative molecular structure shown in the following chemistry FIG. 1:

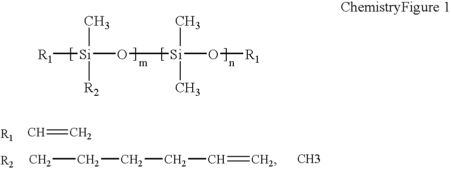

where m and n are integers larger than 0.

The organopolysiloxane contains the vinyl group in the molecule. It is desirable that the vinyl group exists in any part of the molecular, but preferably, in particular, at the end of the molecular structure.

It is allowed that the molecule has either a linear or branch structure, and also allowed that the linear and branch structures coexist. The methyl group coupled to the silicone atom can be substituted by the aliphatic unsaturated hydrocarbon group. However, it is more preferable that containing more than 70 mol %, more preferably more than 80 mol %, of the methyl group unit improves smoothness and release capability.

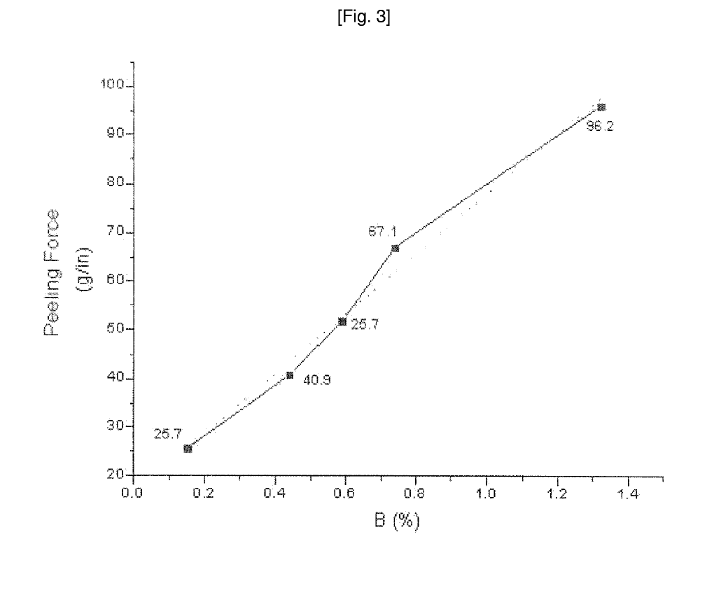

A representative molecular structure of organo hydrogen polysiloxane is shown in the following chemistry FIG. 2, which is used as hardening agent in the silicone release composition of which the peeling force can be controlled according to the invention:

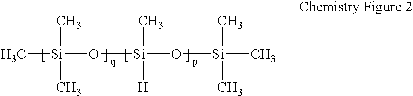

where q and p are integers larger than 0.

The organo hydrogen polysiloxane can have any one of linear, branch or annular structures. Also, a combined structure thereof is allowed. The viscosity or a molecular weight is not limited, provided that good compatibility with the organo hydrogen polysiloxane is implemented. For the amount being used, it is preferred that 0.5 to 1.2 hydrogen atoms are coupled to the silicone atom with respect to one vinyl group of organo hydrogen polysiloxane. If less than 0.5 hydrogen atoms are coupled to the silicone atom with respect to one vinyl group of organo hydrogen polysiloxane, it may be impossible to achieve good hardening capability. If the number of hydrogen atoms exceeds 1.2, elasticity or physical properties after hardening may be lowered. In addition, if the amount of organo hydrogen polysiloxane is more than the amount of organopolysiloxane in the silicone release composition of which the peeling force can be controlled according to the invention, more crosslinking than intended is obtained, resulting in reduced flexibility to cause cracks and thus reduced smoothness on the resultant film.

Preferably, a representative structure of organopolysiloxane resin in the silicone release composition of which the peeling force can be controlled according to the invention has a repetitive structure in a linear or annular shape with the unit shown in the following chemistry FIGS. 3 to 5:

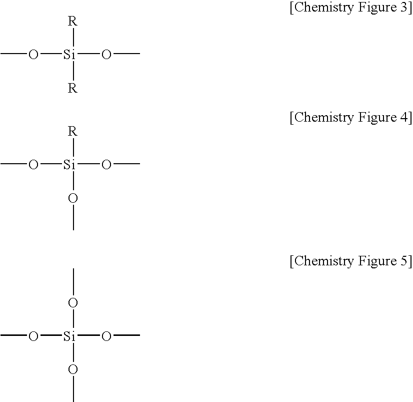

where, preferably, R in the chemistry FIGS. 3 and 4 is the alkyl group, more preferably the methyl group or aliphatic unsaturated hydro carbon, still more preferably the vinyl group, aromatic hydrocarbon, most the phenyl group, etc.

Also, the organopolysiloxane resin in the silicone release composition of which the peeling force can be controlled according to the invention has 0.1 to 20 weight %, of solid matters, preferably 0.15 to 10 weight %. If the amount of contained solid matters is less than 0.15 weight %, a desired high level of peeling force cannot be controlled. If the amount thereof is more than 10 weight %, too high peeling force is obtained, so that it is hard to say that it is a base release material.

Furthermore, the silicone release composition of which the peeling force can be controlled according to the invention can be applied directly onto a plastic film, kraft paper, non-woven fabric, cloth, etc., made of polyester, polypropylene, polyethylene, polyvinyl chloride, nylon, etc. For the purpose of a uniform coating layer and stable peeling force, the content of entire solid matters is preferably 6 to 20 weight %. On the substrate, release agent can be applied after surface treatment such as corona treatment for strong chemical coupling between the substrate and the coating layer. The thickness of the substrate preferably ranges 12 to 1500 micrometer.

### EMBODIMENTS

A release film was produced by coating a polyester film, used as a substrate, with the silicone release composition of which the peeling force can be controlled according to the invention in a conventional way, as shown in the embodiments 1 to 5 in the following Table 1.

### Comparative Examples

A release film was produced by coating a polyester film, used as a substrate, with the silicone release composition of which the peeling force can be controlled according to the invention in a conventional way, as shown in the comparative examples 1 to 3 in the following Table 1.

The following Table 1 shows compositions according to the aforementioned embodiments and comparative examples with the peeling force (g/in) and subsequent adhesion ratio (%) in the embodiments and comparative examples.

TABLE 1

| | Composition of silicone | | | | | Subsequent | |
|---|---|---|---|---|---|---|---|
| | release coating (weight %) | | | | Peeling | adhesion | |
| Category | A | B | C | D | force (g/in) | ratio(%) | Remarks |
| Embodiment 1 | 2.28 | 0.15 | 0.37 | 0.002 | 25.7 | 98.3 | |
| Embodiment 2 | 2.04 | 0.44 | 0.36 | 0.002 | 40.9 | 97.7 | |
| Embodiment 3 | 1.92 | 0.59 | 0.35 | 0.002 | 51.9 | 98.1 | |
| Embodiment 4 | 1.80 | 0.74 | 0.34 | 0.002 | 67.1 | 96.3 | |
| Embodiment 5 | 1.32 | 1.32 | 0.31 | 0.002 | 96.2 | 97.5 | |
| Comparative | 2.04 | X | 0.32 | 0.002 | 17.6 | 96.9 | |
| example 1 | | | | | | | |
| Comparative | 2.28 | X | 0.36 | 0.002 | 15.4 | 98.2 | |
| example 2 | | | | | | | |
| Comparative | 2.40 | X | 0.38 | 0.002 | 16.2 | 96.5 | |
| example 3 | | | | | | | |

(A: organopolysiloxane, B: organopolysiloxane resin, C: organo hydrogen polysiloxane, D: platinum chelate catalyst)

As seen in the above Table 1, in the embodiments according to the invention, the peeling force changes with a given slope depending on the proper composition ratio.

That is, as seen in FIGS. 2 and 3, it is seen that the release film produced with the silicone release composition of which the peeling force can be controlled according to the invention, and according to the embodiments thereof, shows continuously increasing peeling force depending on the amount of the added organopolysiloxane resin (B), with a given slope according to the following math FIG. 1, FIG. 2 being a graph showing peeling force depending on the composition ratio of B/A, that is, organopolysiloxane resin/organopolysiloxane, and C/A, that is, organo hydrogen polysiloxane/organopolysiloxane, and FIG. 3 being a graph showing peeling force depending on the content (%) of the organopolysiloxane resin in the silicone release composition of which the peeling force can be controlled:

Peeling Force=aX+b, [Math Figure 1]

where a=61.62±3.98, b=16.43±3.01, and X=the content (%) of organopolysiloxane resin in the release coating composition. With the result of peeling force analysis of the release film according to the comparative examples, it is seen that there is no change in given peeling force depending on the content of organopolysiloxane (A) and organo hydrogen polysiloxane (C), without adding the organopolysiloxane resin (B).

In the following a method will be described for measuring physical properties of peeling force (g/in) and subsequent adhesion ratio(%), produced according to the embodiments and comparative examples.

(Exemplary Measurement of Physical Properties 1: Measure Peeling Force.)
Preparing a sample.

\textcircled{1} Leave the sample coated with silicone release composition for measurement at 25° C., 65% RH and for 24 hours.

\textcircled{2} After attaching a standard adhesive tape (TESA7475) on the silicone release composition-coated surface, press the sample with a load of 20 g/cm at a room temperature (25° C.) and a high temperature (50° C.) for 24 hours and then measure physical properties of the sample.
measuring instrument: cheminstrument AR-1000
method of measurement:

\textcircled{1} peeling angle of 180° peeling speed of 12 in/min; and

\textcircled{2} sample size: 500 mm×1500 mm, size of measuring peeling force: 250 mm×1500 mm
measurement data: the unit of peeling force is g/in and an average value is calculated by measuring the sample five time.

(Exemplary Measurement of Physical Properties 2: Measure Subsequent Adhesion Ratio.)
Preparing a sample:

\textcircled{1} Leave the sample coated with a silicone release composition for measurement at 25° C. and 65% RH and for 24 hours.

\textcircled{2} After attaching a standard adhesive tape (Nitto 31B) on the silicone release composition coated surface, press the sample with a load of 20 g/cm² at a room temperature (25° C.) for 24 hours.

\textcircled{3} After removing the adhesive tape attached on the silicone release coating surface and attaching it on a flat and clean surface of a PET film, press the film with a 2 kg-tape roller (ASTMD-1000-55T) in one round.

\textcircled{4} Measure peeling force:
measuring instrument: cheminstrument AR-1000
method of measurement:

i) peeling angle of 180°, peeling speed of 12 in/min;

ii) sample size: 500 mm×1500 mm, size for measuring peeling force 250 mm×1500 mm.
Data

$$Subsequent Adhesion Ratio ( \% ) = \frac{\begin{matrix}Peeling force of the adhesive tape attached , \\ then peeled on a silicone surface\end{matrix}}{\begin{matrix}Peeling force of the adhesive tape , \\ not attached on a silicone surface\end{matrix}} \times 100$$

It should be noted that some exemplary embodiments among various embodiments carried out by the inventors have been illustrated, but the technical scope of the invention is not to be limited to those embodiments and can be modified and embodied by those skilled in the art.

The present invention has been described in detail. However, it should be understood that the detailed description and specific examples, while indicating preferred embodiments of the invention, are given merely by way of illustration, since various changes and modifications within the spirit and scope of the invention will become apparent to those skilled in the art from this detailed description.

Use of the verb “comprise” and its conjugations does not exclude the presence of elements or steps other than those stated in a claim. The article “a” or “an” preceding an element does not exclude the presence of a plurality of such elements or steps.

The mere fact that certain measures are recited in mutually different dependent claims does not indicate that a combination of these measures cannot be used to advantage.

1. A silicone water-dispersed release composition, comprising organopolysiloxane, organopolysiloxane resin, organo hydrogen polysiloxane and platinum chelate catalyst, wherein the organopolysiloxane comprises solid matters of 0.15 to 10 weight %, and the oranopolysiloxane resin is in water-dispersed emulsion type, and wherein the peeling force of the release coating composition can be controlled according to the following equation 1:
Peeling Force=a X+b, [Equation 1]
where a=61.62±3.98, b=16.43±3.01, and X=content (%) of organopolysiloxane resin in the silicone release composition.

2. The composition as claimed in claim 1, wherein the composition contains about 6 to about 20 weight % of solid matters.

3. The composition as claimed in claim 2, wherein the organopolysiloxane resin has a repetitive unit selected from the group consisting of: 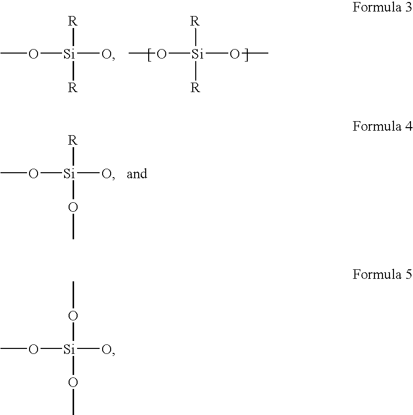
wherein R is methyl, vinyl or phenyl, and the organopolysiloxane resin is straight-chain or circular.

4. The composition as claimed in claim 3, wherein the organo hydrogen polysiloxane has 0.5 to 1.2 hydrogen atoms to be coupled to a silicone atom, for one vinyl group of the organopolysiloxane, in order to achieve good compatibility with the organopolysiloxane.

5. A silicone release film, characterized in that for the film, a silicone release coating layer is formed by coating one side or both sides of a polyester plastic film to have a given coating thickness with the silicone release composition as claimed in claim 1, and of which the peeling force can be controlled.
